(19) United States
(12) Patent Application Publication
(10) Pub. No.: US 2012/0146888 A1
(43) Pub. Date: Jun. 14, 2012

(54) LIQUID CRYSTAL DISPLAY PANEL

(75) Inventors: Chenghung Chen, Shenzhen (CN); Chengming He, Shenzhen (CN)

(73) Assignee: SHENZHEN CHINA STAR OPTOELECTRONICS TECHNOLOGY CO., LTD., Shenzhen (CN)

(21) Appl. No.: 13/217,612

(22) Filed: Aug. 25, 2011

(30) Foreign Application Priority Data
Dec. 8, 2010 (CN) 201010579695.5

(51) Int. Cl. G09G 3/36

(52) U.S. Cl. 345/87

(57) ABSTRACT

A liquid crystal display (LCD) panel includes a plurality of subpixels arranged in a m×n matrix, and n is a multiple of 2. The LCD panel includes n/2 scan lines and 2m data lines. Each scan line is used for controlling two neighboring row subpixels. Every two data lines are used for controlling a column subpixels. When a first scan line turns on first row subpixels and second row subpixels, the 2m data lines output data signal to the first row subpixels and the second row subpixels simultaneously. Because a pixel includes three neighboring subpixels aligning in a column, a number of source driver chips is reduced as well as cost. In addition, the present inventive LCD utilizes two data lines to drive subpixels in a column, so the driving time period is sufficient and upgrading disaply quality.

### BACKGROUND OF THE INVENTION

1. Field of the Invention

The present invention relates to a liquid crystal display panel, and more particularly, to a liquid crystal display panel capable of improving display quality without raising extra cost.

2. Description of Prior Art

A monitor with multiple functions is a key element for use in current consumer electronic products. The demand for the novelty and colorful monitors with high resolution, e.g., liquid crystal displays (LCDs), are indispensable components used in various electronic products such as monitors for notebook computers, personal digital assistants (PDAs), digital cameras, and projectors.

With reference to FIG. 1 showing a conventional LCD panel 100, the LCD panel 100 comprises m×n pixels, each of which comprises three subpixels aligning in a row for showing red, green, and, blue color, respectively. In other words, the LCD panel 100 comprises 3m×n subpixels. In addition, the LCD panel 100 also comprises a number of 3m data lines and a number of n scan lines. Each subpixel is connected to a scan line and a data line.

Referring to FIG. 2 illustrating a timing diagram of driving the LCD panel 100 shown in FIG. 1, scan lines deliver scan driving signals to drive subpixels row by row. In a case of the frame rate W Hz and non-blanking interval, a maximum charging time period t_{A} of each subpixel is t_{A}=1000000(μsec)/(W×n).

Referring to FIG. 3 showing another conventional LCD panel 300, the LCD panel 300 comprises m×n pixels, each of which comprises three subpixels aligning in a row for showing red, green, and, blue color, respectively. In other words, the LCD panel 300 comprises 3m×n subpixels. However, the LCD panel 300 comprises a number of 2n scan lines which is twice as many as the LCD 100 comprises, and a number of 3/2m data lines which is half as many as the LCD 100 comprises. Every two scan lines are used for driving subpixels in a row, while each data line is used for driving subpixels in a column.

Please refer to FIG. 4 illustrating a timing diagram of driving the LCD panel 300 shown in FIG. 3, each scan line drives subpixels row by row while the subpixels in a column are driven by two scan lines. In a case of the frame rate W Hz and non-blanking interval, a maximum charging time period t_{B} of each subpixel is t_{B}=1000000(μsec)/(W×2n), half of the maximum charging time period t_{A} of the LCD panel 100.

Referring to FIG. 5 showing another conventional LCD panel 500, the LCD panel 500 comprises m×n pixels, each of which comprises three subpixels aligning in a column for showing red, green, and, blue color, respectively. In other words, the LCD panel 300 comprises m×3n subpixels. However, the LCD panel 500 comprises a number of 3n scan lines and a number of m data lines. Each subpixel is connected to a scan line and a data line.

Please refer to FIG. 6 illustrating a timing diagram of driving the LCD panel 500 shown in FIG. 5, each scan line drives subpixels row by row while the subpixels in a column are driven by two scan lines. In a case of the frame rate W Hz and non-blanking interval, a maximum charging time period t_{C} of each subpixel is t_{C}=1000000(μsec)/(W×3 n).

By contrast, the LCD panel 100 utilizes a number of 3m data lines, so that a use of more source driver chips to control is necessary and thus raises cost. The LCD panels 300 and 500 utilize respective numbers of 3/2m and m data lines, so that a use of fewer source driver chips to control them lowers the cost. However, in a case that the LCD panels 300 and 500 uses more overlaps of the scan lines of the data lines, greater RC delay occurs. Also, each subpixel of the LCD panels 300 and 500 fails to be charged to a required voltage level during the maximum charging time periods t_{B} and t_{C} which is shorter than t_{A}, resulting in worse display quality of LCD panels 300 and 500.

### SUMMERY OF THE INVENTION

An object of the present invention is to provide a LCD panel capable of improving display quality without raising extra cost to solve problems in the prior art.

In one aspect of the present invention, a liquid crystal display (LCD) panel comprises a plurality of subpixels arranged in a m×n matrix, where n is a multiple of 2. The LCD panel comprises n/2 scan lines and 2m data lines. Each scan line is used for controlling two neighboring row subpixels. Every two data lines are used for controlling a column subpixels.

In another aspect of the present invention, a liquid crystal display (LCD) panel comprises a plurality of subpixels arranged in a m×n matrix, where n is a multiple of 2. The LCD panel comprises n/2 scan lines and 2m data lines. A k-th scan line of the 2/n scan line is electrically connected to (2k−1)-th row subpixels and 2k-th row subpixels to control the (2k−1)-th row subpixels and the 2k-th row subpixels. A (2g−1)-th data line and a 2g-th data line of the 2m data lines are electrically connected to g-th column subpixels. The (2g−1)-th data line is electrically connected to odd row subpixels of g-th column subpixels, while the 2g-th data line is electrically connected to even row subpixels of g-th column subpixels.

In still another aspect of the present invention, a liquid crystal display (LCD) panel comprises a plurality of subpixels arranged in a m×n matrix, where n is a multiple of 2. The LCD panel comprises n/2 scan lines and 2m data lines. A k-th scan line of the 2/n scan line is electrically connected to (2k−1)-th row subpixels and 2k-th row subpixels to control the (2k−1)-th row subpixels and the 2k-th row subpixels. A (2g−1)-th data line and a 2g-th data line of the 2m data lines are electrically connected to g-th column subpixels. The (2g−1)-th data line is electrically connected to even row subpixels of g-th column subpixels, while the 2g-th data line is electrically connected to odd row subpixels of g-th column subpixels.

In contrast to prior art, each pixel of the present inventive LCD panel is capable of being driven to a required voltage level in sufficient driving time period by using fewer source driver chips. Therefore the present inventive liquid crystal display panel is capable of improving display quality without raising extra cost.

These and other features, aspects and advantages of the present disclosure will become understood with reference to the following description, appended claims and accompanying figures.

### BRIEF DESCRIPTION OF THE DRAWINGS

FIG. 1 shows a conventional LCD panel.

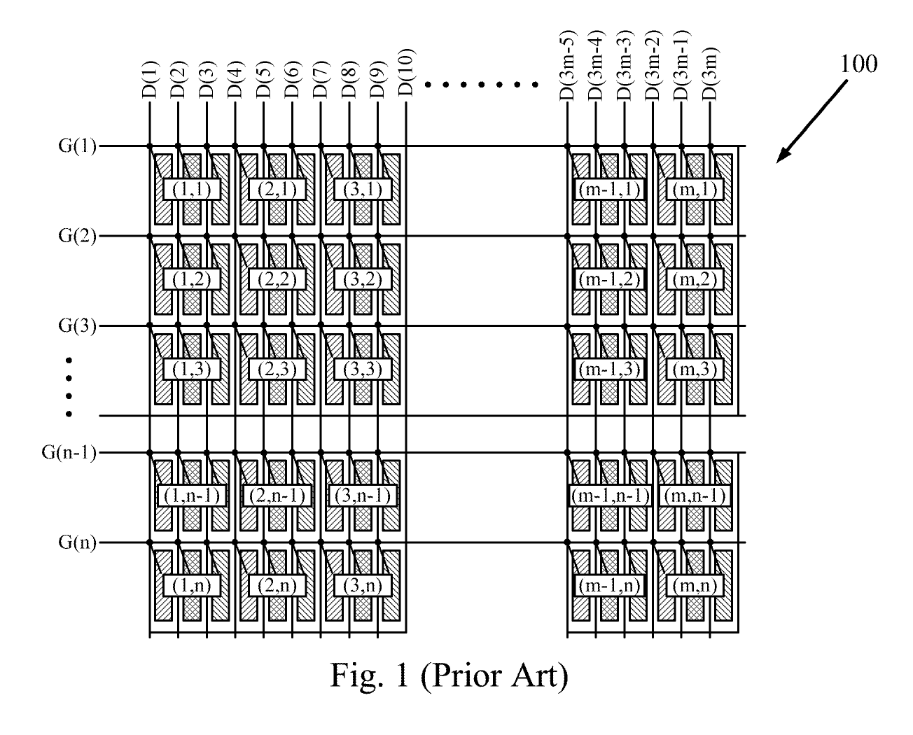

FIG. 2 illustrates a timing diagram of driving the LCD panel shown in FIG. 1.

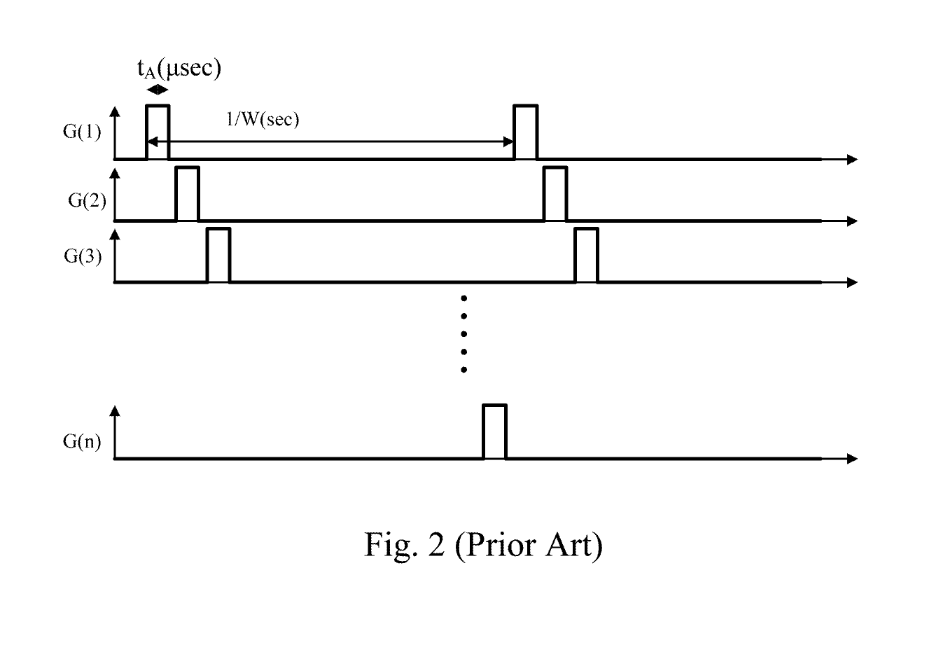

FIG. 3 shows another conventional LCD panel.

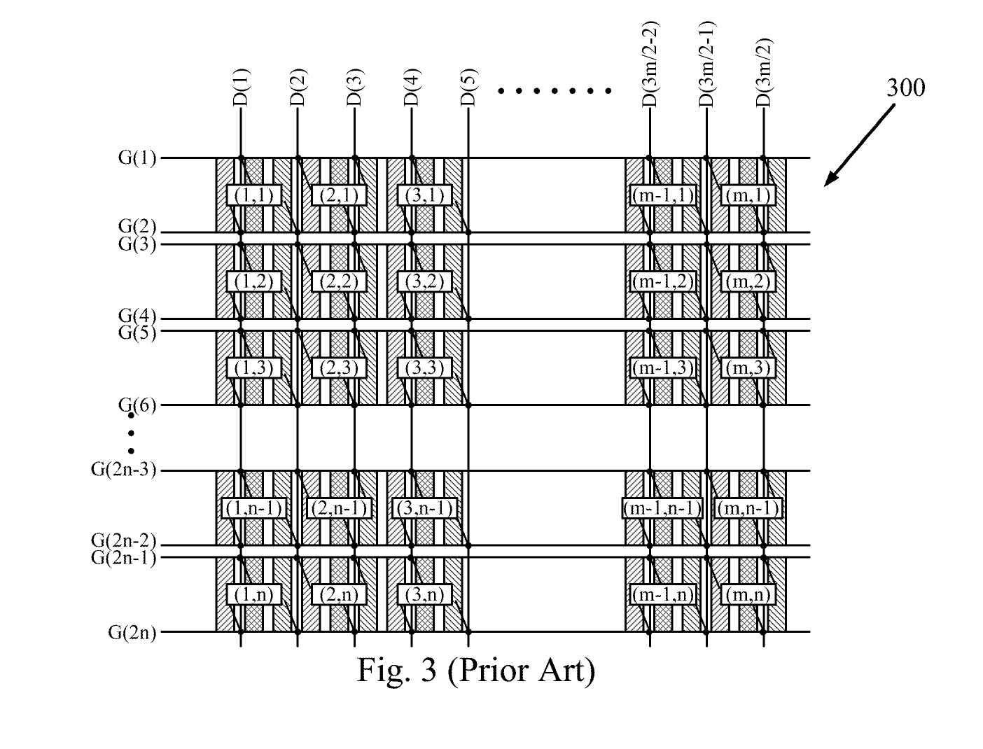

FIG. 4 illustrates a timing diagram of driving the LCD panel shown in FIG. 3.

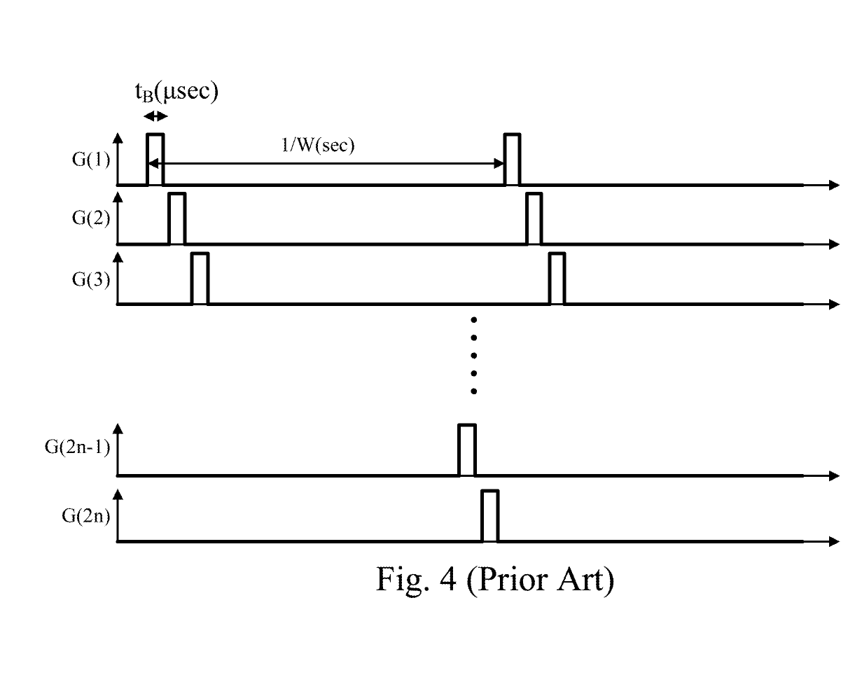

FIG. 5 shows another conventional LCD panel.

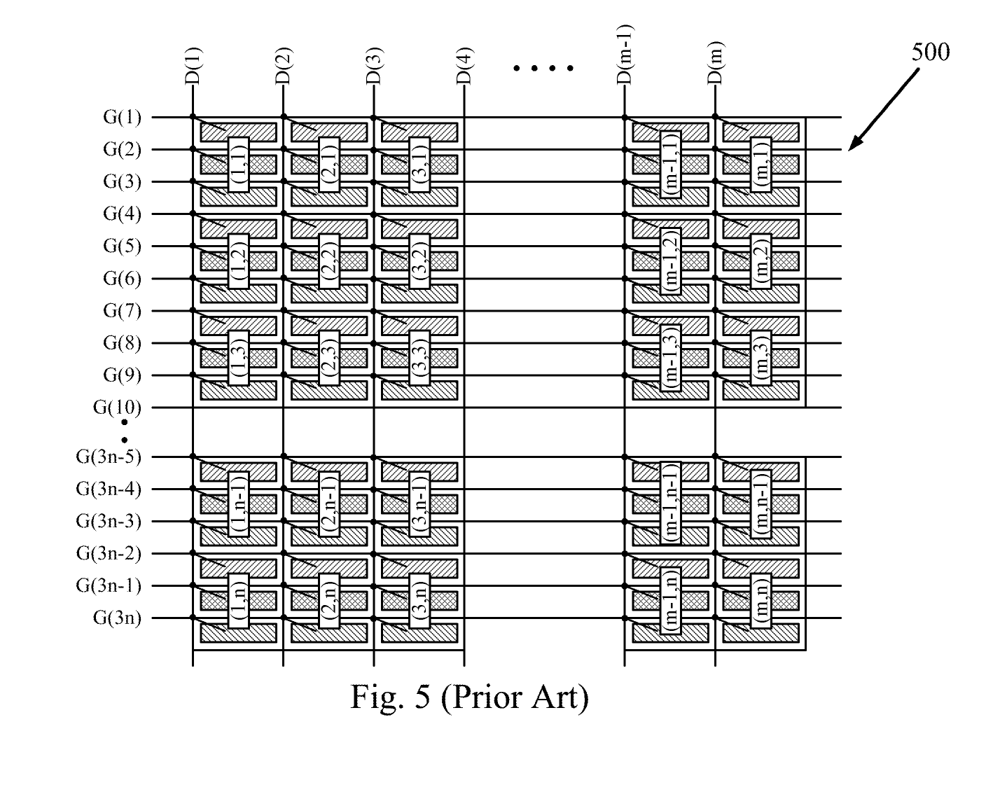

FIG. 6 illustrates a timing diagram of driving the LCD panel shown in FIG. 5.

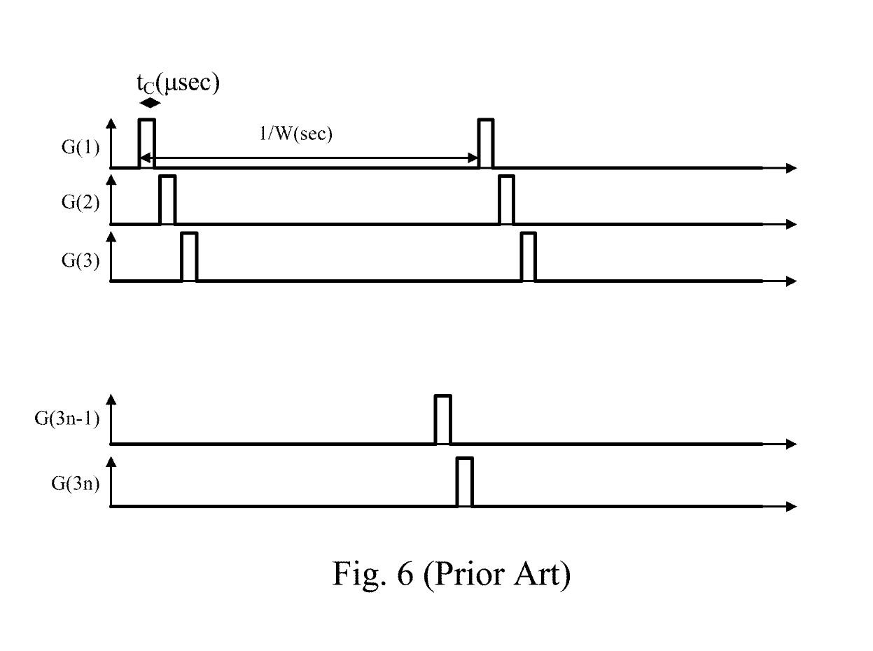

FIG. 7 shows a schematic diagram of a liquid crystal display (LCD) panel according to a first preferred embodiment of the present invention.

FIG. 8 illustrates a timing diagram of driving the LCD panel shown in FIG. 7.

FIG. 9 shows a schematic diagram of an LCD panel according to another preferred embodiment.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

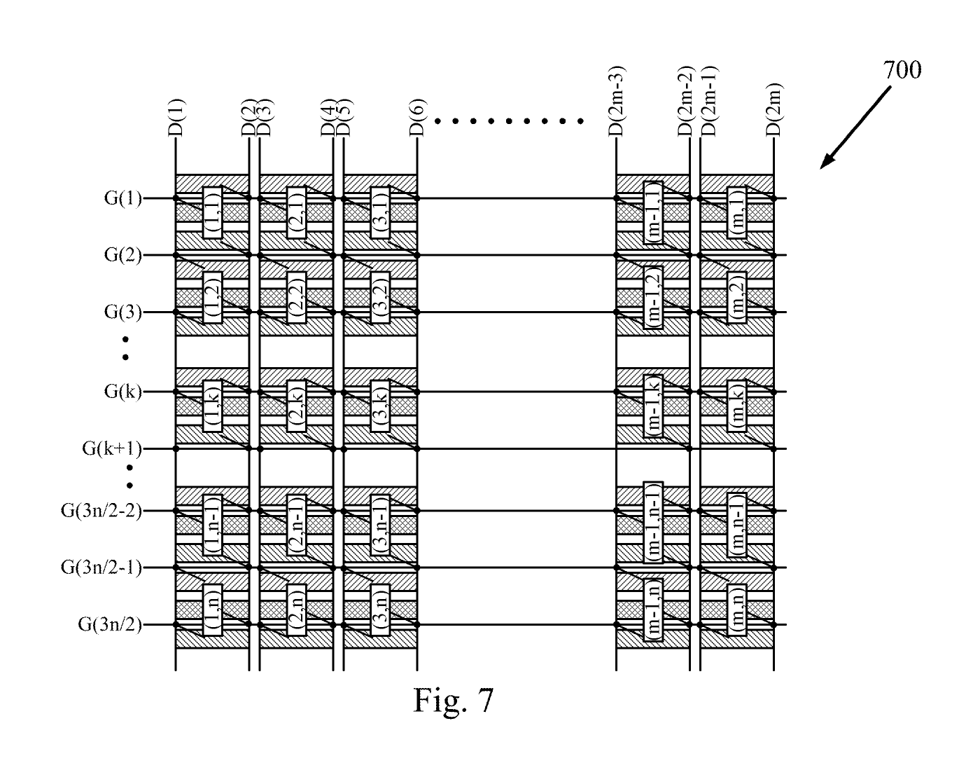

Referring to FIG. 7 showing a schematic diagram of a liquid crystal display (LCD) panel 700 according to a first preferred embodiment of the present invention, the LCD panel 700 with m×n pixels (n is a multiple of 2) is proposed. Each pixel comprises three neighboring subpixels aligning in a column for displaying red, green, and blue color, respectively. In other words, the LCD panel 700 representing a resolution of m×3n comprises a number of m×3n subpixels.

It is noted that the number of scan lines and data lines on the LCD panel and their connectivity are different from the prior art. According to the present invention, the LCD panel 700 comprises a number of 2m data lines D(1)-D(2m) and a number of 3n/2 scan lines G(1)-G(3/2n), where each scan line is coupled to subpixels in two rows, while each two data line is coupled to subpixels in one column.

For example, as shown in FIG. 7, a first scan line G(1) is electrically connected to first row subpixels and second row subpixels. A first data line D(1) is electrically connected to a second, fourth, sixth, . . . , 3n-th subpixels of a first column subpixels, and a second data line D(2) is electrically connected to a first, third, fifth, . . . , (3n−1)-th subpixels of the first column.

Briefly summarized, according to this embodiment, a k-th scan line of the 3n/2 scan lines is electrically connected to and controls (2k−1)-th row subpixels and 2k-th row subpixels. For the 2m data lines, a (2g−1)-th data line and a 2g-th data line are electrically connected to g-th column subpixels, where the (2g−1)-th data line is electrically connected to even subpixels of the g-th column subpixels, and the 2g-th data line is electrically connected to odd subpixels of the g-th column subpixels.

It is noted that, in this embodiment, the (2g−1)-th data line is electrically connected to even subpixels of the g-th column subpixels, and the 2g-th data line is electrically connected to odd subpixels of the g-th column subpixels. Except for the above mentioned connectivity, other connectivity also belongs to the scope of the present invention. For instance, according to another embodiment, the (2g−1)-th data line is electrically connected to odd subpixels of the g-th column subpixels, and the 2g-th data line is electrically connected to even subpixels of the g-th column subpixels. Such connectivity does not contradict the spirit of the present invention.

Practically, each scan line is similarly operated, so take the first scan line G(1) as example. In this embodiment, a scan signal from the first scan line G(1) enables the first row subpixels and the second row subpixles simultaneously. The 2m scan lines alternatively connected to the first and second row subpixels can simultaneously output data signal to the first and second row subpixels and drive the first and second row subpixels.

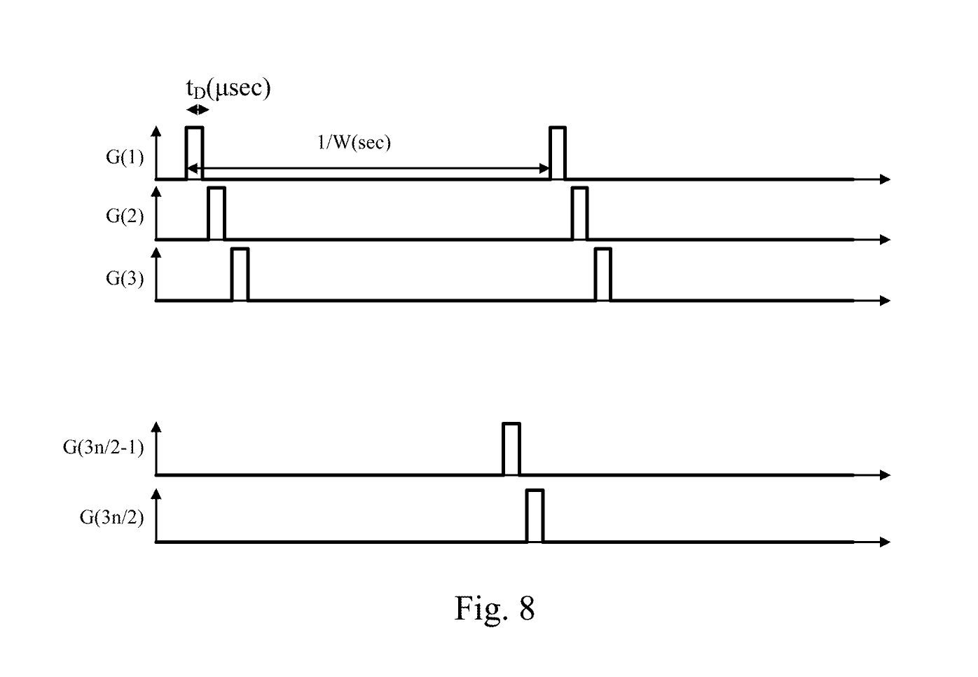

Please refer to FIG. 8 illustrating a timing diagram of driving the LCD panel 700 shown in FIG. 7, each scan line drives subpixels row by row. A driving voltage from each scan line is able to drive subpixels in two rows simultaneously. In a case of the frame rate W Hz and non-blanking interval, a maximum charging time period t_{D} of each subpixel is t_{D}=1000000×2(μsec)/(W×3n).

The relation among the maximum charging time periods of the conventional LCD panels 100, 300, and 500 is t_{A}>t_{D}>t_{B}>t_{C}. Nevertheless, the number of scan lines in the LCD panel 700 is two-third as few as the LCD panel 100, as greatly reduces the number of source driver chips and cost. In contrast to the LCD panels 300 and 500, the charging time period of the LCD panel 700 is sufficient and RC delay is shorter. Therefore, the pixel of the present invention is able to charge required voltage level and upgrade its display quality. Consequently, the present inventive LCD panel is capable of improving display quality without raising extra cost.

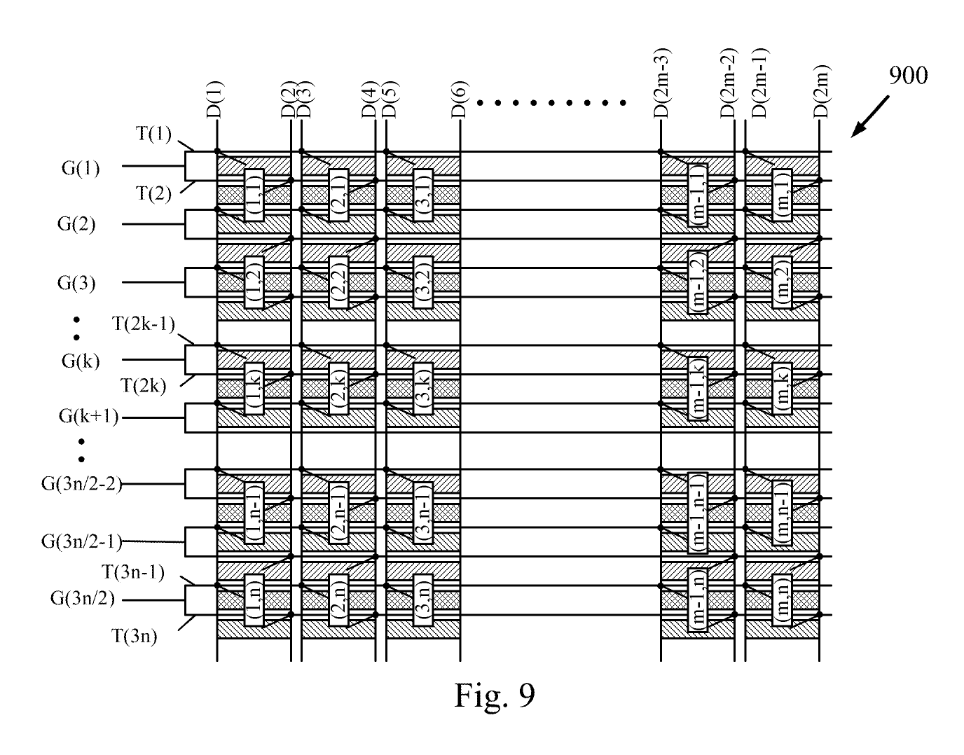

Please refer to FIG. 9 showing a LCD panel 900 according to another preferred embodiment. Except for the number of 3n/2 scan lines for driving the LCD panel 900, the LCD panel 900 comprises a (2k−1)-th transmission line T(2k−1) and a 2k-th transmission line T (2k) extended out of the k-th scan line G(k). The (2k−1)-th transmission line T(2k−1) and the 2k-th transmission line T(2k) are used for simultaneously delivering a scan driving signal to the (2k−1)-th row subpixels and the 2k-th row subpixels. The (2g−1)-th data line and the 2g-th data line are electrically connected to the g-th column subpixels. For brevity, an operation of the LCD panel 900 is similar to that of the LCD panel 700, so no further detailed description is required.

Although the present invention has been explained by the embodiments shown in the drawings described above, it should be understood to the ordinary skilled person in the art that the invention is not limited to the LCD panels 700 and 900, but rather the various changes or modifications thereof are possible without departing from the spirit of the invention.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display (LCD) panel comprising a plurality of subpixels arranged in a m×n matrix, and n being a multiple of 2, characterized in that the LCD panel comprises:
n/2 scan lines, each scan line for controlling two neighboring row subpixels; and
2m data lines, every two data lines for controlling a column subpixels.

2. The LCD panel of claim 1 characterized in that when a k-th scan line of the n/2 scan lines deliver a scan signal to turn on (2k−1)-th row subpixels and 2k-th row subpixels, the 2m data lines output data signal to the (2k−1)-th row subpixels and the 2k-th row subpixels simultaneously.

3. The LCD panel of claim 1 characterized in that a (2g−1)-th data line of the 2m data lines is electrically connected to even row subpixels of g-th column subpixels.

4. The LCD panel of claim 3 characterized in that a 2g-th data line of the 2m data lines is electrically connected to odd row subpixels of g-th column subpixels.

5. The LCD panel of claim 1 characterized in that a (2g−1)-th data line of the 2m data lines is electrically connected to odd row subpixels of g-th column subpixels.

6. The LCD panel of claim 5 characterized in that a 2g-th data line of the 2m data lines is electrically connected to even row subpixels of g-th column subpixels.

7. The LCD panel of claim 1 characterized in that three neighboring subpixels aligning in a column show red, green, and blue color, respectively.

8. A liquid crystal display (LCD) panel comprising a plurality of subpixels arranged in a m×n matrix, and n being a multiple of 2, characterized in that the LCD panel comprises:
n/2 scan lines, a k-th scan line of the 2/n scan line electrically connected to (2k−1)-th row subpixels and 2k-th row subpixels to control the (2k−1)-th row subpixels and the 2k-th row subpixels; and
2m data lines, a (2g−1)-th data line and a 2g-th data line of the 2m data lines being electrically connected to g-th column subpixels, the (2g−1)-th data line being electrically connected to odd row subpixels of g-th column subpixels, and the 2g-th data line being electrically connected to even row subpixels of g-th column subpixels.

9. The LCD panel of claim 8 characterized in that when a k-th scan line of the n/2 scan lines deliver a scan signal to turn on (2k−1)-th row subpixels and 2k-th row subpixels, the 2m data lines output data signal to the (2k−1)-th row subpixels and the 2k-th row subpixels simultaneously.

10. The LCD panel of claim 8 characterized in that three neighboring subpixels aligning in a column show red, green, and blue color, respectively.

11. A liquid crystal display (LCD) panel comprising a plurality of subpixels arranged in a m×n matrix, and n being a multiple of 2, characterized in that the LCD panel comprises:
n/2 scan lines, a k-th scan line of the 2/n scan line electrically connected to (2k−1)-th row subpixels and 2k-th row subpixels to control the (2k−1)-th row subpixels and the 2k-th row subpixels; and
2m data lines, a (2g−1)-th data line and a 2g-th data line of the 2m data lines being electrically connected to g-th column subpixels, the (2g−1)-th data line being electrically connected to even row subpixels of g-th column subpixels, and the 2g-th data line being electrically connected to odd row subpixels of g-th column subpixels.

12. The LCD panel of claim 11 characterized in that when a k-th scan line of the n/2 scan lines deliver a scan signal to turn on (2k−1)-th row subpixels and 2k-th row subpixels, the 2m data lines output data signal to the (2k−1)-th row subpixels and the 2k-th row subpixels simultaneously.

13. The LCD panel of claim 12 characterized in that a (2k−1)-th transmission line and a 2k-th transmission line are extended out of the k-th scan line for simultaneously delivering a scan driving signal to the (2k−1)-th row subpixels and the 2k-th row subpixels to control the (2k−1)-th row subpixels and the 2k-th row subpixels.

14. The LCD panel of claim 11 characterized in that three neighboring subpixels aligning in a column show red, green, and blue color, respectively.
